(19) United States
(12) Patent Application Publication
(10) Pub. No.: US 2004/0147323 A1
(43) Pub. Date: Jul. 29, 2004

(54) Gaming systems

(76) Inventors: David Trevor Cliff, Southville (GB); Rycharde Jeffery Hawkes, Bristol (GB); Colin Andrew Low, Gloucestershire (GB)

Correspondence Address: HEWLETT-PACKARD COMPANY, Intellectual Property Administration, P.O. Box 272400, Fort Collins, CO, 80527-2400, US

(21) Appl. No.: 10/692,210

(22) Filed: Oct. 23, 2003

(30) Foreign Application Priority Data
Oct. 31, 2002 (GB) 0225419.1

(51) Int. Cl. G06F 17/00

(52) U.S. Cl. 463/42

(57) ABSTRACT

A gaming system comprises a gaming platform, such as a mobile platform, on which a player can play a game, a communication network for providing communication between the gaming platform and a game server, and a prize supplier database for providing prize supplier location information. When a game prize signal is generated, the game server communicates location information about an appropriate prize supplier for receipt by the player. The game server selects the appropriate prize supplier from the prize supplier database, this selection being effected, for example, on the basis of closeness to the location of the gaming platform. A corresponding gaming server apparatus and game-prize information method are also provided.

### FIELD OF THE INVENTION

The present invention relates to gaming systems, communication apparatus and communication methods.

### BACKGROUND OF THE INVENTION

With the growth of internet access, many games are being played far more widely than before. Further with access to the internet becoming far easier from mobile internet accessible devices such as mobile phones, personal digital assistants (PDAs) and laptops these games are being played from almost any conceivable location.

Many of these games are played using web-sites specifically intended for the purpose, such as www.gamesville.com. Some such web-sites offer prizes for successful contestants, for instance in the form of tokens (see www.pogo.com).

It is an aim of preferred embodiments of the present invention to obviate or overcome a disadvantage of the prior art, whether that disadvantage is referred to herein or otherwise.

### SUMMARY OF THE INVENTION

According to one aspect of the present invention, there is provided a gaming system comprising:

a game server,

a gaming platform usable by a player to play a game associated with the game server,

a communication network for providing communication between the gaming platform and the game server, and

a prize supplier database for storing data, including location data, about prize suppliers;

the game server comprising a prize signal generator for generating a prize signal upon a predetermined game occurrence resulting from playing of the game using the gaming platform, and a control arrangement for responding to the generation of said prize signal by communicating location information about an appropriate prize supplier for receipt by said player, the control arrangement being arranged to select said appropriate prize supplier from the prize supplier database on the basis of at least one selection parameter.

The prize supplier is, for example, a vendor, such as a store, of items or services to be used as prizes.

Preferably, the at least one selection parameter comprises a location associated with the player; the at least one parameter can further comprise at least one of a prize type indicated by the player and prize availability at the prize suppliers.

In one preferred embodiment, the gaming platform is a mobile gaming platform and the at least one selection parameter comprises the current location of the gaming platform, the system further comprising a location determining apparatus for determining the location of the gaming platform. In this case, the control arrangement of the game server is advantageously arranged to select said appropriate prize supplier as the prize supplier that is closest to the said current location of the gaming platform. “Closeness” can be in time or distance. Furthermore, the location information preferably comprises at least one of:

the location of the selected prize supplier;

the position of the selected prize supplier relative to the current location of the gaming platform; and

a route guide to the selected prize supplier from the current location of the gaming platform.

In another embodiment, the at least one selection parameter comprises a specific location input by the player, the system further comprising means for accepting user input of said specific location. In this case, the control arrangement of the game server is advantageously arranged to select said appropriate prize supplier as the prize supplier that is closest to the said specific location. “Closeness” can be in time or distance. Furthermore, the location information preferably comprises at least one of:

the location of the selected prize supplier;

the position of the selected prize supplier relative to said specific location; and

a route guide to the selected prize supplier from said specific location.

Where the gaming platform is a mobile gaming platform (whether or not part of the embodiment first-mentioned above), the game is advantageously a location based game, with the system further comprising a location determining apparatus for determining the location of the gaming platform. In this case, the game server advantageously uses location data from the location determining apparatus to affect the game play.

Where the location information comprises a route guide to the selected prize supplier from a location associated with the player (whether or not part of the embodiments mentioned above), then if the gaming platform is a mobile gaming platform, the appropriate prize supplier is preferably selected in dependence on the current location of the gaming platform, the system further comprising a location determining apparatus for determining the location of the gaming platform.

Advantageously, the control arrangement of the game server is arranged to communicate the location information to the gaming platform. Preferably, the system is provided with means for transmitting a prize code signal for a player and/or means for transmitting a prize entitlement signal to the selected prize supplier. The prize vendor prize entitlement signal is preferably the same as the prize code signal transmitted for the player.

According to a second aspect of the present, there is provided apparatus comprising:

a game server for communicating, via a communication network, with at least one gaming platform on which a player can play a game associated with the game server, and

a prize supplier database for storing data, including location data, about prize suppliers;

the game server comprising a prize signal generator for generating a prize signal upon a predetermined game occurrence resulting from playing of said game on the gaming platform, and a control arrangement for responding to the generation of said prize signal by communicating location information about an appropriate prize supplier for receipt by said player, the control arrangement being arranged to select said appropriate prize supplier from the prize supplier database on the basis of at least one selection parameter.

According to a third aspect of the present invention, there is provided a game-prize information method comprising:

(a) communicating game data via a communication network between a game server and a gaming platform on which a player can play a game associated with the game server,

(b) upon a prize signal being generated from playing of the game on the gaming platform, selecting on the basis of at least one selection parameter, an appropriate prize supplier from a prize supplier database, and

(c) communicating location information about the selected prize supplier for receipt by said player.

Preferably, the method further comprises generating the prize signal upon a predetermined game occurrence.

### BRIEF DESCRIPTION OF THE DRAWINGS

The present invention will now be described, by way of example only, with reference to the drawings that follow; in which:

FIG. 1 is a schematic functional illustration of a gaming system according to the present invention.

FIG. 2 is a schematic functional illustration of the game server.

FIG. 3 is a functional flow diagram illustrating a method of operation of the present invention.

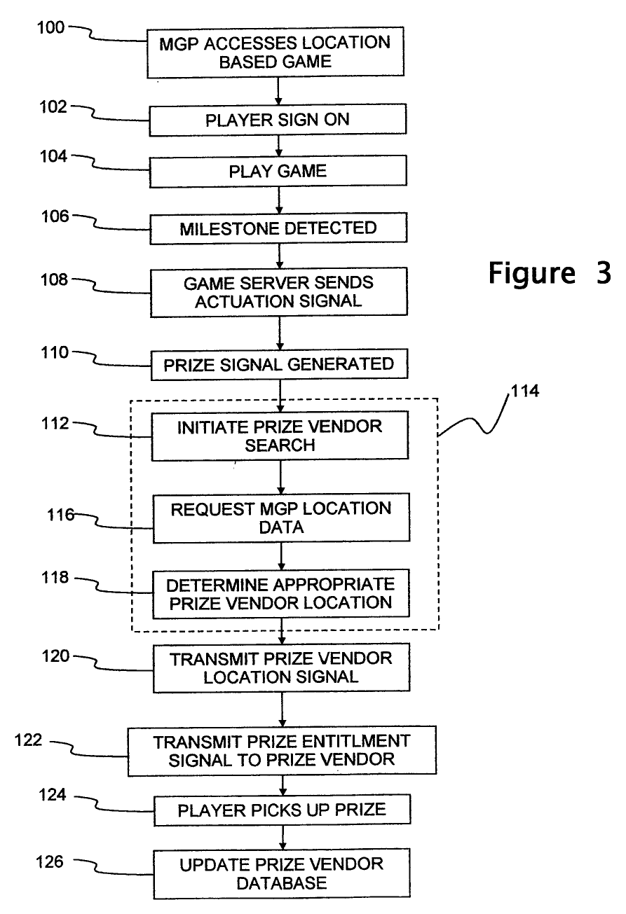

### BEST MODE OF CARRYING OUT THE INVENTION

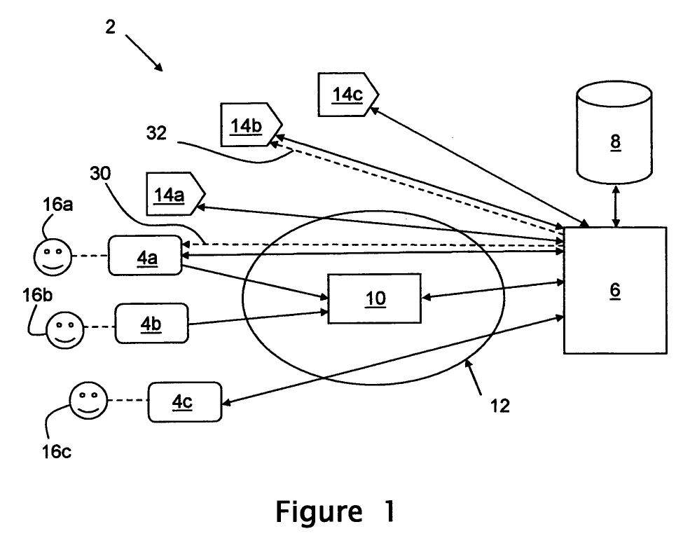

Referring to FIG. 1 of the drawings that follow, there is shown a gaming system 2 comprising a plurality of mobile gaming platforms (MGPs) 4a, 4b, 4c, a game server 6, a prize vendor database 8, a location server 10 and a communication network indicated schematically at 12. Also shown in FIG. 1 is a plurality of prize vendors 14a, 14b, 14c. It is to be understood that the term “prize vendor” means a vendor of items or services to be used as prizes; of course, as an alternative to prize vendors, it is possible to use prize suppliers who provide prizes to prize winners but do not otherwise deal in the items or services that constitute prizes.

The MGPs 4a, 4b, 4c may be embodied in a variety of apparatus such as a mobile phone (4a), a laptop (4b) or a vehicle (4c) incorporating gaming apparatus. The MGPs 4 incorporate input/output devices and a display. Any player 16a, 16b, 16c can play a game on each MGP 4a, 4b, 4c to which they have access. The games operating on MGPs 4a, 4b, 4c can be of almost any type. They may be single player games, single player games using data from the games server 6, single player games played on the games server 6 (in which case the MGP 4 can act as a slave or thin client), or multiplayer games, in each case using the (or another) communication network 12 to communicate with game server 6.

In preferred embodiments of the present invention the game in relation to which the invention operates is a location based game. That is some aspect, feature or facet of the game is dependent on or affected by the location of the MGP 4. For instance, the game could be an observational quiz based on the locality of the MGP 4, a multiplayer game in which gameplay is modified by proximity to objects, locations or other MGPs, or a game in which players are given clues that ultimately lead them to a target.

Game server 6 is a computer server on which games for mobile gaming platforms 4a, 4b, 4c can run, which can maintain data to support mobile gaming and/or can operate features of the present invention. Game server 6 monitors the location of MGPs 4 via location server 10.

Prize vendor database 8 contains data on the location of and prize types available from the plurality of prize vendors 14 that have subscribed to the system.

Location server 10 acts as a location determining apparatus to determine the location of MGPs 4. In the case of a location based game, location server 10 either constantly or periodically (usually relatively frequently) determines the location of the respective MGPs 4. In the case of non-location based games, the location of the MGPs 4 may only need to be determined when an appropriate prize vendor is to be determined, or in some embodiments not at all.

The location of the MGPs 4 can be determined by location server 10 in a variety of known ways. For instance, if only an approximate location is required, in the case of a MGP 4 using a cellular telephony network, the current cell in which the MGP 4 is located can be used. Alternatively, signal times or strengths to base stations can be used to better approximate the position of the MGP 4. As another alternative a global positioning system (GPS) can be utilized. This last option may be especially convenient if the MGP 4 is located in a vehicle including a GPS based satellite navigation system for position data.

Communication between the MGPs 4a, 4b, 4c and game server 6 is enabled by and via the communication network 12 which typically will be a cellular wireless telephony network that may, optionally, use the internet for connectivity to the game server 6 or other players.

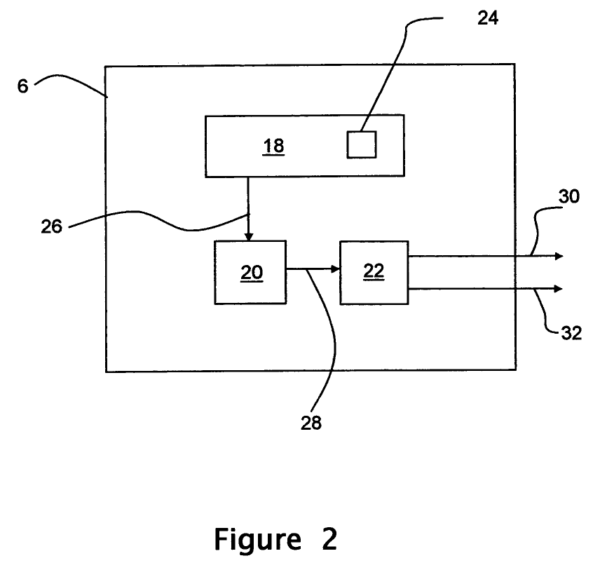

Referring to FIG. 2 of the drawings that follow, the games server 6 comprises a processor 18, a prize signal generator 20 and a prize vendor locator 22.

Processor 18 is a computational resource for operation of embodiments of the present invention and for controlling games run thereon. Computer programs (schematically 24) for operation of the present invention can be executed on processor 18.

Upon receipt of an actuation signal 26, prize signal generator 20 generates a prize signal (indicated schematically at 28 in FIG. 2) when a game event occurs on a MGP. Any desired game event can be used to initiate generation of the prize signal 28, such as a new high score, achievement of a certain number of points, reaching a predefined point in a game, or simply answering a question correctly. If the game is run on or is using game server 6, the prize signal generator 20 can be actuated by processor 18 directly from the gameplay. If the MGP 4 is operating a game independently of game server 6, MGP 4 is configured to transmit an actuating signal to game server 6 for generation of the prize signal 28.

A method of operation of a preferred embodiment of the present invention described above will now be set out.

In this embodiment of MGP 4a is accessing a location based game (step 100) over the cellular telephony network which is being run on game server 6. When first accessing a game on game server 6, the player is invited to sign on (step 102), which can include various personal data as well as an indication of preferred prize pick-up location and prize type. Options for pick-up locations may include locally to a predetermined location such as the player's home address or place of work, or local to the current position of the MGP 4a. Prize types can include coupons, tokens, gifts or cash prizes. As not all prize vendors may supply all prize types, if the player has indicated a preference, this can be taken into account when determining an appropriate prize vendor location.

Player 16a then plays a game, which may be one of many available of game server 6, in step 104.

In step 106 player 16a achieves a milestone in the game being played, which milestone is a predefined game occurrence and is detected by game server 6. In step 108 game server 6 sends an actuation signal 26 to prize signal generator 20 which, in step 110 generates a prize signal 28.

In step 112, prize vendor locator 22 detects the prize signal 28 and initiates a prize vendor search (generically step 114) in prize vendor database 8. With reference to the preference information supplied by the player 16a in step 102, the prize vendor search requests MGP 4a location data from location server 10 (step 116) and interrogates the prize vendor database 8 to determine the most appropriate prize vendor location for the player 4a (step 118). The nearest (in distance) prize vendor may not be selected, for instance if the prize vendor database 8 indicates that the respective prize vendor does not have a prize of the type (or types) specified by player 16a, if the player 16a has asked for a prize vendor location nearest to a predetermined position or if the player 16a has requested that the nearest prize vendor in travel time be notified. For this last function, game server 6 may include a route finder or be configured to obtain routing information from elsewhere. Thus, an appropriate prize vendor 14b can be determined according to predetermined prize vendor selection parameters and rules generated from step 102. It is open to a player to modify their profile in the game server 6 to modify the parameters and rules on which as appropriate prize vendor selection is made.

Once a prize vendor location has been determined, game server 6 transmits (step 120) a prize vendor location signal 30 to player 16a via the MGP 4a. Additionally a prize code signal may be transmitted to player 16a as part of prize vendor location signal 30 as a security measure, in which case game server 6 acts as means for transmitting a prize code signal for a player.

Additionally, in step 122 a prize entitlement signal 32 (FIG. 1) is transmitted to the appropriate prize vendor 14b by game server 6, which acts as means for doing so. Prize entitlement signal 32 includes means for the prize vendor 14b to confirm that a person presenting themselves for collection of a prize is entitled to claim it. The prize entitlement signal 32 may be the name of the player, or a duplicate of the prize code signal. The prize vendor can also use this signal to ensure it has a corresponding prize ready for delivery to the player.

In step 124 the player 16a visits prize vendor 14b to pick up a predetermined prize or prize type. The prize vendor 14b may then, in step 126, notify the prize vendor database of the prize that has been collected. This may be useful marketing information and can be used to determine whether prize vendor 14b has a given prize type in stock or is too busy for further prize winners to be directed there.

Prize vendors 14 will make a payment to an organisation for inclusion in the list of prize vendors 14 on prize vendor database 8.

Thus, a preferred embodiment of the present invention provides a gaming system 2 comprising a MGP 4 on which a player 16 can play a game, a communication network 12 for providing communication between the MGP 4 and a game server 6, and a prize vendor database 8 for providing prize vendor database 8 for providing prize vendor location data, the system 2 being configured whereby when a game prize signal 28 is generated the location of an appropriate prize vendor 14 from the prize vendor database 8 is determined and communicated for a player.

It will be appreciated that many variants are possible to the above-described embodiments of the invention. Thus, although in the foregoing embodiments the gaming platforms 4 have been described as mobile platforms, it is also possible for non-mobile gaming platforms to be used in addition or alternatively to the mobile gaming platforms. Furthermore, it is to be understood that the game server 6 need not be implemented as a single computing apparatus but could be distributed in form with, for example, the prize signal generator 20 separately located from the processor 18.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A gaming system comprising:
a game server,
a gaming platform usable by a player to play a game associated with the game server,
a communication network for providing communication between the gaming platform and the game server, and
a prize supplier database for storing data, including location data, about prize suppliers;
the game server comprising a prize signal generator for generating a prize signal upon a predetermined game occurrence resulting from playing of the game using the gaming platform, and a control arrangement for responding to the generation of said prize signal by communicating location information about an appropriate prize supplier for receipt by said player, the control arrangement being arranged to select said appropriate prize supplier from the prize supplier database on the basis of at least one selection parameter.

2. A gaming system according to claim 1, in which the said at least one selection parameter comprises a location associated with the player.

3. A gaming system according to claim 2, in which the said at least one selection parameter further comprises at least one of a prize type indicated by the player and prize availability at the prize suppliers.

4. A gaming system according to claim 2, in which the gaming platform is a mobile gaming platform and the said location associated with the player is the current location of the gaming platform, the system further comprising a location determining apparatus for determining the location of the gaming platform.

5. A gaming system according to claim 4, in which the communication network is a cellular network and the location determining apparatus comprises part of the communication network to locate the gaming platform to a given cell of the cellular communication network.

6. A gaming system according to claim 4, in which the control arrangement of the game server is arranged to select said appropriate prize supplier as the prize supplier that is closest to the said current location of the gaming platform.

7. A gaming system according to claim 4, in which the location information comprises at least one of:
the location of the selected prize supplier;
the position of the selected prize supplier relative to the current location of the gaming platform; and
a route guide to the selected prize supplier from the current location of the gaming platform.

8. A gaming system according to claim 2, in which the said location associated with the player is a specific location input by the player, the system further comprising means for accepting user input of said specific location.

9. A gaming system according to claim 8, in which the control arrangement of the game server is arranged to select said appropriate prize supplier as the prize supplier that is closest to the said specific location.

10. A gaming system according to claim 8, in which the location information comprises at least one of:
the location of the selected prize supplier;
the position of the selected prize supplier relative to said specific location; and
a route guide to the selected prize supplier from said specific location.

11. A gaming system according to claim 1, in which the gaming platform is a mobile gaming platform.

12. A gaming system according to claim 11, in which the game is a location based game, the system further comprising a location determining apparatus for determining the location of the gaming platform.

13. A gaming system according to claim 1, in which the location information comprises a route guide to the selected prize supplier from a location associated with the player.

14. A gaming system according to claim 13, in which the gaming platform is a mobile gaming platform and said location associated with the player is the current location of the gaming platform, the system further comprising a location determining apparatus for determining the location of the gaming platform.

15. A gaming system according to claim 1, in which said control arrangement is arranged to communicate the location information to the gaming platform.

16. A gaming system according to claim 1, in which the system further comprises means for transmitting a prize code signal for a player.

17. A gaming system according to claim 1, in which the system further comprises means for transmitting a prize entitlement signal to the selected prize supplier.

18. Apparatus comprising:
a game server for communicating, via a communication network, with at least one gaming platform on which a player can play a game associated with the game server, and
a prize supplier database for storing data, including location data, about prize suppliers;
the game server comprising a prize signal generator for generating a prize signal upon a predetermined game occurrence resulting from playing of said game on the gaming platform, and a control arrangement for responding to the generation of said prize signal by communicating location information about an appropriate prize supplier for receipt by said player, the control arrangement being arranged to select said appropriate prize supplier from the prize supplier database on the basis of at least one selection parameter.

19. Apparatus according to claim 18, in which the said at least one selection parameter comprises a location associated with the player.

20. Apparatus according to claim 19, in which the said at least one selection parameter further comprises at least one of a prize type indicated by the player and prize availability at the prize suppliers.

21. Apparatus according to claim 19, in which the gaming platform is a mobile gaming platform and the said location associated with the player is the current location of the gaming platform, the apparatus further comprising means for communicating with location determining apparatus for determining the location of the gaming platform.

22. Apparatus according to claim 21, in which the control arrangement of the game server is arranged to select said appropriate prize supplier as the prize supplier that is closest to the current location of the gaming platform.

23. Apparatus according to claim 21, in which the location information comprises at least one of:
the location of the selected prize supplier;
the position of the selected prize supplier relative to the current location of the gaming platform; and
a route guide to the selected prize supplier from the current location of the gaming platform.

24. Apparatus according to claim 18, in which the said location associated with the player is a specific location input by the player, the apparatus further comprising means for accepting user input of said specific location.

25. Apparatus according to claim 24, in which the control arrangement of the game server is arranged to select said appropriate prize supplier as the prize supplier that is closest to the said specific location.

26. Apparatus according to claim 24, in which the location information comprises at least one of:
the location of the selected prize supplier;
the position of the selected prize supplier relative to said specific location; and
a route guide to the selected prize supplier from said specific location.

27. Apparatus according to claim 18, in which the gaming platform is a mobile gaming platform.

28. Apparatus according to claim 21, in which the game is a location based game.

29. Apparatus according to claim 18, in which the location information comprises a route guide to the selected prize supplier from a location associated with the player.

30. Apparatus according to claim 29, in which the gaming platform is a mobile gaming platform and said location associated with the player is the current location of the gaming platform, the apparatus further comprising means for communicating with a location determining apparatus for determining the location of the gaming platform.

31. Apparatus according to claim 18, in which said control arrangement is arranged to communicate the location information to the gaming platform.

32. Apparatus according to claim 18, in which the game server further comprises means for transmitting a prize code signal for a player.

32. Apparatus according to claim 18, in which the game server further comprises means for transmitting a prize entitlement signal to the selected prize supplier.

33. A game-prize information method comprising:
(a) communicating game data via a communication network between a game server and a gaming platform on which a player can play a game associated with the game server,
(b) upon a prize signal being generated from playing of the game on the gaming platform, selecting on the basis of at least one selection parameter, an appropriate prize supplier from a prize supplier database, and
(c) communicating location information about the selected prize supplier for receipt by said player.

34. A method according to claim 33, further comprising generating the prize signal upon a predetermined game occurrence.

35. A method according to claim 33, in which in (b) the said at least one selection parameter comprises a location associated with the player.

36. A method according to claim 35, in which the said at least one selection parameter further comprises at least one of a prize type indicated by the player and prize availability at the prize suppliers.

37. A method according to claim 35, in which the gaming platform is a mobile gaming platform and the said location associated with the player is the current location of the gaming platform, the method further comprising determining the current location of the gaming platform and using this location in (b) to select the appropriate prize supplier.

38. A method according to claim 37, in which in (b) the said appropriate prize supplier is selected to be the prize supplier that is closest to the said current location of the gaming platform.

39. A gaming system according to claim 37, in which the location information comprises at least one of:
the location of the selected prize supplier;
the position of the selected prize supplier relative to the current location of the gaming platform; and
a route guide to the selected prize supplier from the current location of the gaming platform.

40. A method according to claim 35, in which the said location associated with the player is a specific location input by the player.

41. A method according to claim 40, in which in (b) said appropriate prize supplier is selected to be the prize supplier that is closest to the said specific location.

42. A method according to claim 40, in which the location information comprises at least one of:
the location of the selected prize supplier;
the position of the selected prize supplier relative to said specific location; and
a route guide to the selected prize supplier from said specific location.

43. A method according to claim 33, in which the gaming platform is a mobile gaming platform.

44. A method according to claim 43, in which the game is a location based game.

45. A method according to claim 33, in which the location information comprises a route guide to the selected prize supplier from a location associated with the player.

46. A method according to claim 45, in which the gaming platform is a mobile gaming platform and said location associated with the player is the current location of the gaming platform, the method further comprising determining the current location of the gaming platform and using this location in (b) to select the appropriate prize supplier.

47. A method according to claim 33, in which in (c) the location information is communicated to the gaming platform.

48. A method according to claim 33, in which (c) further involves transmitting a prize code signal for a player.

49. A method according to claim 33, in which (c) further involves transmitting a prize entitlement signal to the selected prize supplier.
